(19) United States
(12) Patent Application Publication
(10) Pub. No.: US 2016/0239928 A1
(43) Pub. Date: Aug. 18, 2016

(54) SYSTEM AND METHOD FOR INDICATING PROFILE ACCURACY

(71) Applicant: David DuMais, Richardson, TX (US)

(72) Inventor: David DuMais, Richardson, TX (US)

(21) Appl. No.: 14/971,941

(22) Filed: Dec. 16, 2015

Related U.S. Application Data
(60) Provisional application No. 62/116,365, filed on Feb. 13, 2015.

(51) Int. Cl. G06Q 50/00; G06Q 10/00

(52) U.S. Cl. CPC G06Q 50/01; G06Q 10/00

(57) ABSTRACT

A system and method for providing an accuracy rating of profile information based on reviews given by the reviewers of profile information. Initially, an extension is installed and activated on the computing system of a profile visitor to detect a unique identifier associated with a profile. In the system, an independent rating server computes an accuracy rating based on user-provided information, and then provides the accuracy rating to a profile visitor. Accordingly, an accuracy rating on a rating server is stored in association with the unique identifier for each profile. The rating server communicates directly with the computing system of the visitor to receive the unique identifier of the profile owner, and transmits back an accuracy rating associated with the unique identifier. By integrating the accuracy rating with profile information of the profile owner, the accuracy rating is displayable for a profile visitor

### RELATED APPLICATION AND CLAIM OF PRIORITY

The present patent document claims the benefit of the filing date under 35 U.S.C. §119(e) of Provisional U.S. Patent Application Ser. No. 62/116,365 filed on 13 Feb. 2015 to common inventor Dumais, the entire contents of which is incorporated herein by reference.

### TECHNICAL FIELD OF THE INVENTION

The present invention relates to internet based services that allow reviewers to rate the accuracy of profile information, and, more particularly, to an automated system and method for collecting, and summarizing profile accuracy ratings.

### STATEMENT OF A PROBLEM ADDRESSED BY THE INVENTION

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

A person (who may be a “profile owner”) may post an advertisement to sell stuff on internet sites such as Craigslist®, or upload their personal information to promote themselves on websites such as eHarmony®, Christian Mingle®, or Match.com®. And, unfortunately, sometimes profile owners lie about information that they provide. Some websites have systems that enable other users to provide feedback, such as eBay's® feedback. However, these systems are owned by the website, and may be manipulated by the website or profile owner.

Various websites allow a visitor/reviewer to rate information that profile owners post, such as Facebook's “like” buttons. In these systems, information server(s) manage rating data.

A few systems have been developed to rate the accuracy of the reviewer's authenticity, such as one used by Angie's List®. These systems rate the accuracy of a reviewer's authenticity by creating reviewer credentials, or communicating with a reviewer via phone or e-mail.

These systems maintain a database to collect the reviews from past visitors of the website, and, like Angie's List, sometimes display an average rating to new visitors to the profile.

Accordingly, what is needed are systems, methods, and devices that enable viewers of internet profiles to trust that the information that they are viewing is as objectively true as possible.

### SUMMARY

In one embodiment, the present invention defines a system and method for providing an accuracy rating of profile information, and displays a rating directly on the webpage and/or profile being rated. The invention may include an extension installed and activated on the computing system. The extension enables a user to receive an accuracy rating from the rating server, and in particular an accuracy rating regarding a profile being viewed by the user. The extension further implements a method comprising the acts of receiving profile information from the information server, detecting a unique identifier associated with the profile owner, sending a request for an accuracy rating to the rating server, and displaying the accuracy rating.

In another embodiment, the rating server receives requests from the visitor's computing system over a communication link, retrieves an accuracy rating from the database, and transmits the accuracy rating back to the computing system or a third party computing system. In yet another embodiment, the rating server asks a reviewer to provide ratings related to profile information of a profile owner.

The rating server computes a raw score with respect to the profile information based on a predetermined weighting of each question, and a number of questions answered by the reviewer. Next, the rating server computes and determines an accuracy rating of the profile owner based on raw scores, ratings given by the multiple reviewers, and/or a comparison with other profiles also rated within the system.

In an alternative embodiment of the invention, the rating server has the capability to send text messages or e-mails, or interact with the computing system of the visitor or the reviewer over a communication network, such as the internet.

### BRIEF DESCRIPTION OF THE DRAWINGS

Various aspects of the invention, as well as an embodiment, are better understood by reference to the following exemplary embodiment. For better understanding of the invention, the exemplary embodiment should be read in conjunction with the drawings in which:

FIG. 1 illustrates an exemplary visitor interaction;

FIG. 2 illustrates an exemplary representation of profile information overlaid with a rating;

FIG. 3 is a flow chart of process for implementing an exemplary embodiment of the invention;

FIG. 4 illustrates an example representation of the profile information overlaid with a dialog box;

FIG. 5 illustrates an example representation of the profile information overlaid with the question; and

FIG. 6 illustrates the computing system in accordance with an example embodiment of the present invention.

### EXEMPLARY EMBODIMENT

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time of patent filing. Since one of ordinary skill in the art may recognize substantially equivalent structures or substantially equivalent acts to achieve the same results in exactly the same way in light of the following exemplary embodiment, or to achieve the same results in a not dissimilar way; the following exemplary embodiment should not be interpreted as limiting the invention to one embodiment.

Likewise, individual aspects (sometimes-called species) of the invention are provided as examples. Accordingly, one of ordinary skill in the art may recognize from a following exemplary structure (or a following exemplary act) a substantially equivalent structure or substantially equivalent act to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated. (For example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

As will be understood by those of ordinary skill in the art, various structures and devices are depicted in block diagram form in order to avoid unnecessarily obscuring the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### DESCRIPTION OF THE DRAWINGS

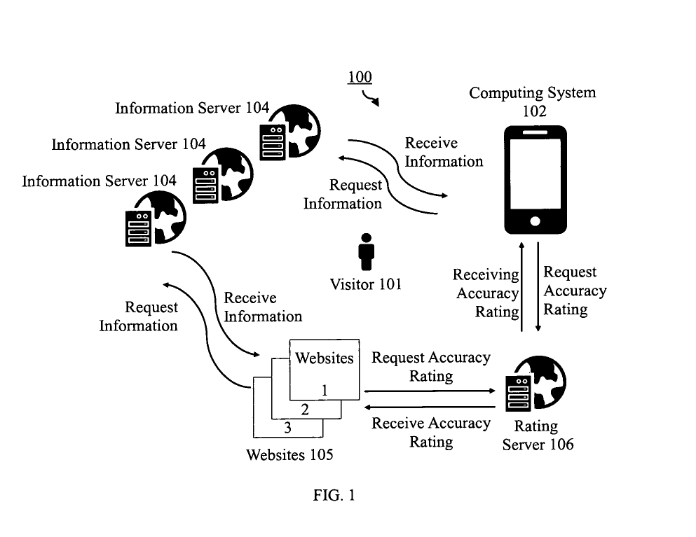

Better understanding of the invention can be obtained by examining the figures, in which FIG. 1 illustrates one embodiment of a system 100 according to the teachings of the invention. In FIG. 1 it is seen that a visitor 101 may interact through a computing system 102 with information servers 104. Information servers 104 store information related to Websites 105, which may include both website-specific data as well as data related to a profile owner(s) and their profile(s). It is understood that the term web site, as referred to here includes different web brand names, such as eHarmony®, Match.com®, Christian Mingle® and Plenty of Fish®, for example. Accordingly, the visitor 101 may receive profile information regarding a profile owner from a rating server 106, and the rating may be unified across each of a plurality of websites. Additionally, a rating for a first profile owner may be the same across the websites 105, substantially similar across the websites 105, or be altered to be customized for each of the websites 105. The profile information regarding a profile owner allows the visitor 101 to assess or otherwise receive an indication of a profile's accuracy. Communication between the rating server 106, computing device 102, the information servers 104 and computing system 102 may take place over wireless and/or wire line networks. This system enables ratings to show up on the actual website and page that is being rated, or for the rating to show up on third-party websites (or in other words, websites owned or operated by other companies or entities unaffiliated with the website hosting the profile owner information being evaluated, assessed or scored).

The information server 104 and the rating server 106 are hardware-stack independent, meaning that they can be maintained as independent databases, or hosted “in the cloud” at specific host providers or in a general could service; they are also software-stack independent, meaning that they can comprise open-source, proprietary or blended software systems. Information servers 104 may store profile information, including personal identities, professional experience associated with a profile owner, promotional attributes of a profile owner, or any other information related to a person, a group, or a company (collectively, profile owners). The rating server 106 computes and stores an accuracy rating associated with a profile owner (the computation of the accuracy rating is discussed in detail, below).

The computing system 102 may be a laptop, desktop, mobile phone, or any device capable of processing data and communicating over a network with the rating servers 106 and/or the information servers 104. In practice, when the computing system 102 opens a program (or “app”) associated with a user profile(s) having ratings, it sends a request for profile information. Typically, the computing system 102 sends the request when a user of the computing system (the visitor 101) visits a user profile by, for example, entering the uniform source locator (URL) associated with a website 105. Alternatively, there may be multiple interactions of the visitor with the computing system 102 before a request is sent to the information server 104.

One or more of the information servers 104 receives the request, and returns profile information to the computing system 102 in a computer compatible format. The computing system 102 then parses the information of the profile owner, and displays it on a browser or other interface, such as a mobile application. Additionally, the computing system 102 is adapted to send requests to the rating server 106 and to receive accuracy ratings there-from. Accordingly, responsive to the request, the rating server 106 is adapted to retrieve an accuracy rating from storage and send it back to the computing system 102. Next, the computing system 102 receives the accuracy rating and integrates the rating into displayed profile information, and in one embodiment does so as an “overlay.” In alternative embodiments, the accuracy rating may be displayed in a toolbar, a separate frame, a task bar or any other user-visible application interface.

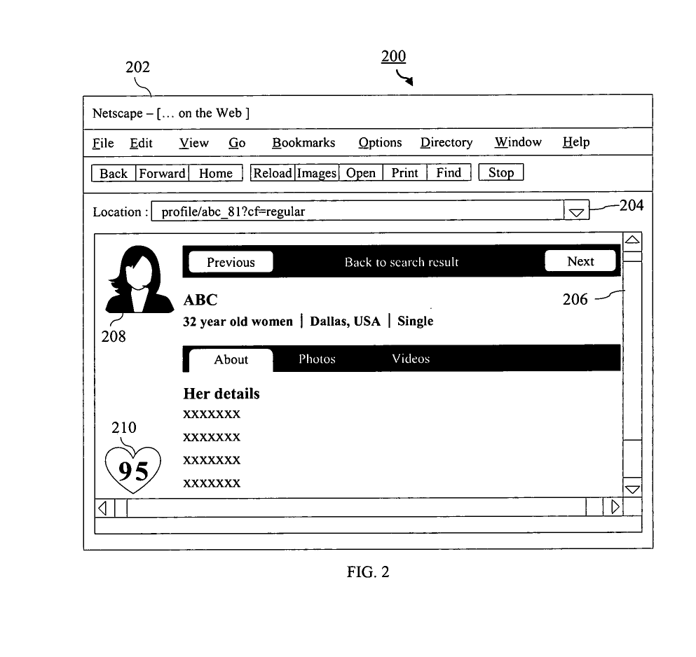

FIG. 2 illustrates an exemplary embodiment of a webpage in which an accuracy rating is presented as an icon 210 that overlays the profile information including a photo 208 of the profile owner (the accuracy rating being received from the rating server 106). Accordingly, here, a browser 202 receives the profile information from the information server 104, and the accuracy rating from the rating server 106 (the accuracy rating is illustrated as being integrated into the profile information on the browser). The accuracy rating is requested from the rating server 106 based on a unique identifier associated with the profile owner, and the review is displayed on the web page being displayed. However, other techniques to detect the profile owner may be used, such as the profile owner's″ mobile number, date of birth, or other personal details, for example.

As shown in the FIG. 2, the visitor/user is able to view an accuracy rating as an icon 210 overlaid on a webpage 206. Accordingly, the user can select the icon 210 to provide a review of the profile information. When a visitor selects the icon 210 displaying accuracy rating, he/she becomes a reviewer of the profile information 208.

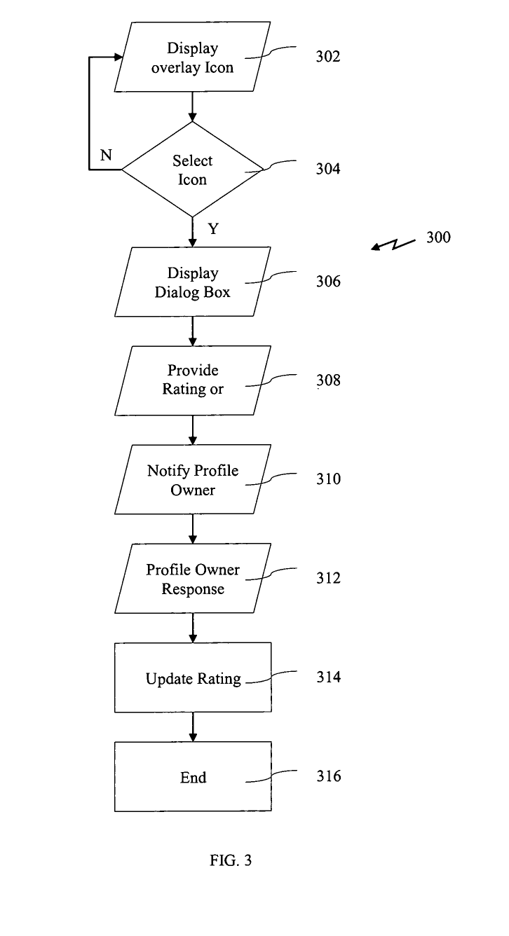

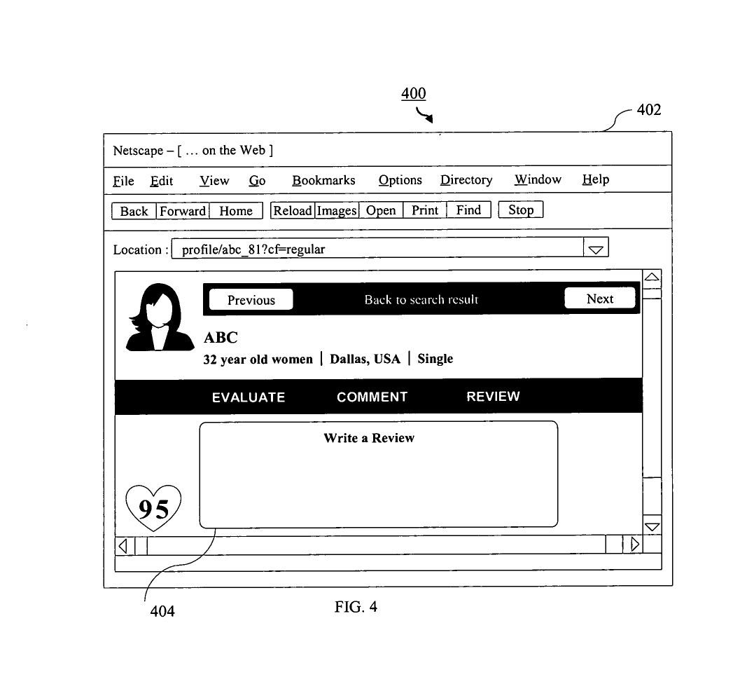

FIG. 3 illustrates a validity rating algorithm 300. As shown in FIG. 3 in a display act 302 visitor selects the icon 210, and the algorithm 300 begins. In one embodiment, the icon displays a number associated with a current accuracy rating, and displays the accuracy rating on the web page being rated. The accuracy rating indicates the accuracy and degree of reliability of profile information presented in the profile. In alternative embodiments, other scoring numbers, ranks, or icons, for example, are used to convey degrees of reliability or other metrics that may be important to a profile's viewers. The profile visitor may interact with the icon in a selection icon query 304. In the section icon query the visitor may select the icon 210, as indicated by the “Y” decision path, the algorithm 300 proceeds to a display dialog box act 306. In accordance with an exemplary embodiment of the invention, a dialog box 404 (shown in FIG. 4, which illustrates, as a whole 400, an example representation of the profile information overlaid with the dialog box 404) appears over the profile information of the webpage 402.

In the event that it is a profile owner's first rating, the icon could display teasing information such as “be their first to provide rating” in order to cajole a visitor into rating a profile. Alternatively, if the profile information with respect to the profile owner has been rated previously, a summary rating is visible in the icon 210.

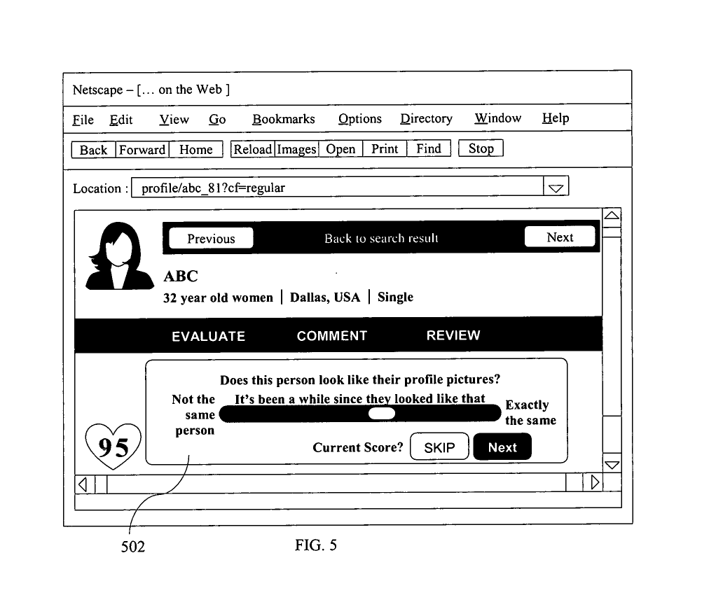

Turning again to the algorithm 300, in a rating and review act 308, the visitor may review the profile's information and provide rating(s) with respect to the information. A set of questions related to personality or integrity of profile owner or profile information would be asked to determine the accuracy rating, such as asking if the person in the profile's picture is actually the person who shows up to meet offline. The questions may be open ended or ranking-type, or where the reviewer has to give a rating on a discrete number scale. For example, FIG. 5 illustrates a representation of a browser displaying a question regarding profile information, where a feedback bar 502 is used to receive/process user feedback in a quick and intuitive way.

Following the provide rating act 308, the profile owner receives a notification that their rating or ranking has been augmented, reviewed, or changed in a notify profile owner act 310, and the profile owner is offered an opportunity to reply in a profile owner response act 312. Preferably, in both the rating act 308 and the notify profile owner act 310 each respective user is rated via any known or foreseeable system or method. After a response from the profile owner is received, the accuracy rating is updated in an update rating act 314, and the algorithm 300 ends 316.

Turning again to FIG. 5, a user can provide inputs on a 1 to 10 scale (which may be discrete, or sliding/analog, or subjective—such as: high, medium, low). And, in an alternative embodiment, an open-ended question may be provided, where each question may have specific weight, and an administrator of the rating server 106 may decide the weight of question.

Preferably, an accuracy rating is determined based on the rating given by the reviewer with respect to question asked to them. In one embodiment a raw score is first calculated based on the rating given by the reviewer, weight of the respective question, and number of question answered by the user. For example, assume a user assigns an 8 out of 10 for a rating parameter, and assume that this question has been assigned a weight of 14; the result is that 11.2 points are added to the raw score (0.8×14). In contrast, if the user had given an 8 out of 10 rating to a question having a weight of five (“5”) the impact on their raw score would be 4.0 (being 0.8×5).

In an alternative, questions may relate to profile integrity as well as profile owner personality/attributes. And, an administrator may assign weight to categories of questions. For example, the weight to the questions related to the integrity could be 65 and personality could be 35.

Administrators may choose to eliminate an outlier rating(s) (which could be viewed as unreliable—perhaps revenge or the feedback of a promoter-friend—and potentially skew data).

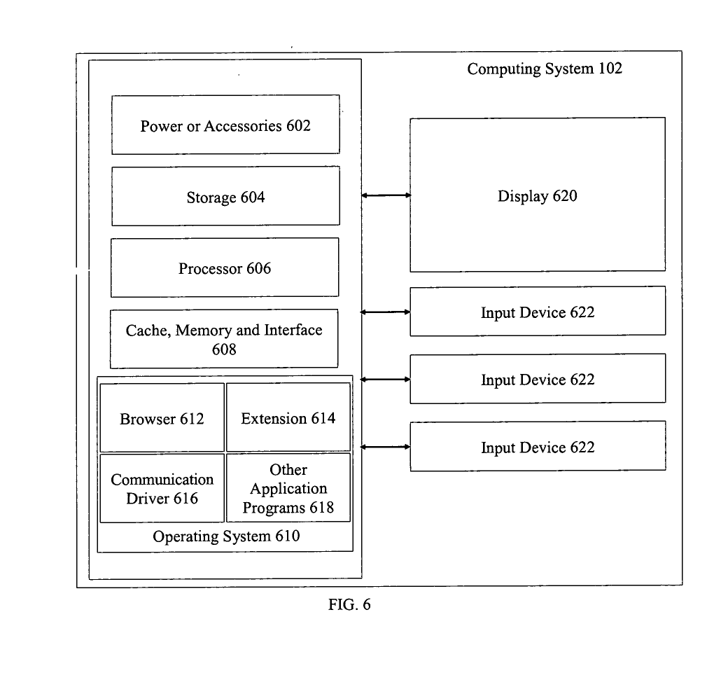

FIG. 6 illustrates a computing system's components according to the teachings of the invention. Preferably, the computing system 102 comprises an operating system 610, a storage/memory 604, a processor 606, and a cache 608. For interaction with users, the computing system 102 also includes a display 620, a plurality of input devices 622, such as touch-screens, microphones, mouse, track-pads, keyboards, and/or touch-pads, for example. In one embodiment, the computing system 102 preferably communicates with the rating server 106.

The operating system of the computing system 102 comprises various software codes including browser 612, communication driver 616, extension 614, and any other application program 618 that is usable for the operation of the computing system. The communication driver 616, in coordination with hardware, initiates and maintains a communications link over the network.

The extension 614 parses profile information and detects an identifier embedded with respect to the profile owner. Accordingly, when profile information is displayed on a browser, the extension 614 sends a request to the rating server 106 so that the accuracy rating may be stored (and is associated with the identifier of the profile owner). Then, the rating server 106 retrieves the accuracy rating from the storage, and sends it to the computing system; next, the extension receives the accuracy rating and integrates it into the profile information. In an exemplary embodiment, the icon is overlaid on the webpage that displays profile information, and the icon displays the accuracy rating.

Preferably, the identifier uniquely identifies each profile owner, and associates the profile owner with their profile information (the profile information being preferably stored on the information server 104). The identifier may be a part of the URL of the webpage displaying the profile information. Additionally, it may be a data point of the profile information such as mobile number, or a combination of the data point such as combination of the last name and date of birth. Further, the accuracy rating is stored with respect to the identifier in the rating server 106. Since there is preferably no direct communication between the information server 104 and rating server 106, the extension 614 extracts the identifier from the profile information and sends this information to the rating server 106. When there is no accuracy data with respect to the identifier, the rating server 106 returns no value, but asks the visitor to review and rate the profile information. In practice, the accuracy rating value is blank (in other words, not displayed) in the icon until the rating server receives first review with respect to the profile information.

The profile information is preferably displayed on an application (aka “program”) executing on the computing system. In alternative embodiment, the extension is toolbar, taskbar, widget, or any other code executing on a computing system.

In an alternative embodiment, the rating server can also compute an accuracy rating by comparing the raw score with respect to the profile owner to profile information stored on the multiple information servers.

Alternatively, the system provides an inventive rating system that integrates or displays ratings on third party web sites/App. This means, in part, that users do not have to go to a specific, central website to post a review. Moreover, the reviews are not published on a separate website. Rather, profile visitors may use websites organically, as if the inventive system is not there at all, and the accuracy rating are shown via an “overlay” on top of the third-party website.

While there are many ways to implement the invention, both known and foreseeable; the inventive process is preferably initiated via a user-download of an extension. The extension recognizes, among other things, the type of web page the visitor is looking at (for example, browser type, or device type, for example). Then, the extension is adapted to detect when a profile type, such as a dating profile, is being visited, and then displays the icon in a predetermined location. The icon is selected and displayed with ranking/score information via a fetch or callback to the rating server.

Of course, while the specification above is specifically applied to profile websites such as dating sites, the invention is applicable to any type of web site/App that evaluates a person or a thing or a service. Thus, though the invention has been described with respect to a specific preferred embodiment, many advantages, variations and modifications will become apparent to those skilled in the art upon reading the present application. It is therefore the intention that the appended claims and their functional equivalents be interpreted as broadly as possible in view of the prior art to include all such variations and modifications.

What is claimed is:

1. A system for providing an accuracy rating with respect to profile information associated with a profile owner user page and stored on the information server, comprising:
at least one information server that store a first profile information associated with a profile owner, the first profile information including demographic information;
a rating server that maintains an accuracy rating for profiles stored on an information server, where
the accuracy rating stored for the profile owner is a function of at least a selection portion of the profile information stored on the information server, and
the rating server computes the accuracy rating as a function of ratings given by at least one reviewer of the first profile information; and
a visitor computing system associated with a visitor, the visitor viewing the profile associated with the profile owner;
the visitor computing system having an extension that detects that an accuracy rating is associated with the profile owner, and communicates with the rating server to request and receive the accuracy rating associated with the profile owner; and
the extension integrates the accuracy rating of the profile owner with the profile owner's profile, while displaying the profile information on the user interface of the visitor computing system.

2. The system according to claim 1 wherein the visitor computing system executes an application that is independent from the information server and the rating server.

3. The system according to claim 1 wherein the computing system comprises a mobile communication device capable of communicating through a wireless communication network.

4. The system according to claim 1 wherein the rating system is independent of any specific application that incorporates profile information.

5. The system according to claim 1 wherein the information server stores profiles associated with an internet dating site, or a professional networking site.

6. The system according to claim 1 wherein the rating server computes the accuracy rating based on feedback provided by the visitor, the feedback being directed to the profile information.

7. The system according to claim 1 wherein the ratings given by at least one reviewer of the first profile information comprises ratings by at least a first reviewer associated with a first website and a second reviewer associated with a second web site.

8. The system according to claim 1 wherein the visitor answers at least one question presented by the rating server.

9. The system according to claim 1 wherein the rating server communicates with the visitor and profile owner over internet, or telecommunication network.

10. The system according to the claim 1 wherein the rating server is adapted to send a communication to the visitor via a second communication channel.

11. A method for providing an accuracy rating for a first profile information stored on an information server, comprising:
at a computing system user interface, requesting via a communication link that an information server provide a first profile information, the first profile information associated with a profile owner and a displayable profile;
displaying the profile information and the profile on the user interface;
activating an extension on the computing system of a visitor, wherein the extension parses the first profile information received from the information server and detects an identifier embedded therein, the identifier associated with the profile owner;
transmitting a request for the accuracy rating associated with the identifier to a rating server;
receiving the accuracy rating from the rating server; and
integrating and displaying the accuracy rating with the first profile information on the user interface, wherein the rating server computes the accuracy rating as a function of responses provided by visitors to the profile.

12. The method according to the claim 11 wherein the rating server computes a raw score for the first profile information.

13. The method according to the claim 12 wherein the raw score is a function of responses provided by visitors to the profile.

14. The method according to claim 13 wherein each response is weighted to assign a predetermined importance.

15. The method according to claim 13 wherein at least one response is related to the profile owner's integrity and at least one response is related to the profile owner's personality.

16. The method according to the claim 13 wherein responses include open-ended text responses.

17. The method according to the claim 11 wherein the rating server determines accuracy rating based on the raw scores, computed based on the rating or answers given by the reviewer or the visitor with respect to the profile information on the information server.

18. The method according to claim 11 wherein the rating server receives the identifier from the extension over the communication link, retrieves the accuracy rating associated with the identifier from storage, and transmits the accuracy rating to the extension.

19. The method according to claim 11 wherein the rating server receives the rating from the visitor, verifies the authenticity of the visitor, sends the rating to the profile owner, provides an opportunity to the profile owner to respond, requests the visitor to modify their rating, and re-computes the raw score.

20. The method according to the claim 11 wherein the identifier is embedded in the Uniform Source Locator (URL) or source code of the web page.
